(19) United States
(12) Patent Application Publication
(10) Pub. No.: US 2024/0152828 A1
(43) Pub. Date: May 9, 2024

(54) TASK MANAGEMENT SERVICE SERVER CAPABLE OF PERFORMING TASK MANAGEMENT FOR AN ELECTRONIC TERMINAL AND THE OPERATING METHOD THEREOF

(71) Applicant: FRANKLIN TECHNOLOGY INC., Seoul (KR)

(72) Inventors: Changsoo YU, Hwaseong-si (KR); Ok Chae KIM, Seoul (KR)

(73) Assignee: FRANKLIN TECHNOLOGY INC., Seoul (KR)

(21) Appl. No.: 18/221,390

(22) Filed: Jul. 13, 2023

(30) Foreign Application Priority Data
Nov. 4, 2022 (KR) 10-2022-0146356

(51) Int. Cl. G06Q 10/0631

(52) U.S. Cl. CPC G06Q 10/06311

(57) ABSTRACT

A task management service server capable performing task management for an electronic terminal and the operating method thereof are provided to support an administrator to more easily perform task setting and management for an electronic terminal on a predetermined person to be managed.

### CROSS-REFERENCE TO RELATED APPLICATIONS

This application claims priority to and the benefit of Korean Patent Application No. 10-2022-0146356 filed in the Korean Intellectual Property Office on Nov. 4, 2022, the entire contents of which are incorporated herein by reference.

### TECHNICAL FIELD

The present disclosure relates to a task management service server capable of performing task management for an electronic terminal and the operating method thereof.

### BACKGROUND ART

Recently, as various online-connectable electronic terminals such as desktop PCs, smart phones, and tablet PCs are spread, the use of electronic terminals by children and adolescents is also increasing.

Since the vulnerable, such as children and adolescents, require constant attention and observation from their guardians, it is possible to consider introducing a technique to help guardians manage the behavior of their guardians by using electronic terminals.

In this regard, by setting a predetermined task to be performed in a specific time period on an electronic terminal possessed by a person to be managed, such as children and adolescents, it is possible to consider the introduction of system technology that induces the person to be managed to perform a task set in the electronic terminal in the person to be managed.

Specifically, if the administrator wants the person to be managed to brush their teeth between 17:00 and 19:00, a task ‘to brush their teeth from 17:00 to 19:00’ is set on the electronic terminal possessed by the person to be managed, so it will be possible to induce the person to be managed to perform the task set on his or her electronic terminal.

However, in order to induce the person to be managed to actively perform the task set on his/her electronic terminal, it is necessary to provide an appropriate reward when the person to be managed completes the predetermined task.

Therefore, it is necessary to research a task management service technology that supports to set a task in a desired direction administrator for the electronic terminal of a predetermined person to be managed, and when the person to be managed competes performing a specific task has performed a specific task, can notify a result of performing the task to the manager's terminal, and enables providing a reward according to the performing of the task to the person to be managed.

### SUMMARY OF THE INVENTION

The present disclosure has been made in an effort to provide a task management service server capable performing task management for an electronic terminal and the operating method thereof to support an administrator to more easily perform task setting and management for an electronic terminal on a predetermined person to be managed.

An exemplary embodiment of the present disclosure provides a task management service server capable of performing task management for an electronic terminal, which includes: a code transmission unit generating, when receiving a processing request for a registration procedure for registering a terminal to be subjected to the task management from a management terminal of an administrator, an identification code for identifying a connection session with the management terminal, and transmitting the generated identification code to the management terminal; a registration unit identifying, when receiving the first unique identification information assigned to the first electronic terminal jointly with the identification code from the first electronic terminal which becomes the subject of the task management, which acquires the identification code transmitted from the management terminal, the connection session with the management terminal based on the identification code, and storing the first unique identification information as the unique identification information for the terminal which becomes the subject of the task management assigned by the administrator in the management list database; a setting request unit transmitting a setting request instruction for requesting setting a task list to be performed by a user of the first electronic terminal to the management terminal; and a task setting unit storing, when receiving, from the management terminal, a first task list, in which the first task list is a list constituted by information on each of a plurality of tasks specified for the user of the first electronic terminal to perform and information on a time zone in which each of the plurality of tasks is to be performed in response to the setting request instruction, the first task list in a management list database to correspond to the first unique identification information, generating an instruction message from instructing the user of the first electronic terminal to perform the task according to the first task list, and then transmitting the first task list and the instruction message to the first electronic terminal.

Another exemplary embodiment of the present disclosure provides an operating method of a task management service server capable of performing task management for an electronic terminal, which includes: generating, when receiving, from a management terminal of an administrator, a processing request for a registration procedure for registering a terminal to be subjected to the task management, an identification code for identifying a connection session with the management terminal, and transmitting the generated identification code to the management terminal; identifying, when receiving the first unique identification information assigned to the first electronic terminal jointly with the identification code from the first electronic terminal which becomes the subject of the task management, which acquires the identification code transmitted from the management terminal, the connection session with the management terminal based on the identification code, and storing the first unique identification information as the unique identification information for the terminal which becomes the subject of the task management assigned by the administrator in the management list database; transmitting a setting request instruction for requesting setting a task list to be performed by a user of the first electronic terminal to the management terminal; and storing, when receiving, from the management terminal, a first task list, in which the first task list is a list constituted by information on each of a plurality of tasks specified for the user of the first electronic terminal to perform and information on a time zone in which each of the plurality of tasks is to be performed in response to the setting request instruction, the first task list in a management list database to correspond to the first unique identification information, generating an instruction message from instructing the user of the first electronic terminal to perform the task according to the first task list, and then transmitting the first task list and the instruction message to the first electronic terminal.

According to an exemplary embodiment of the present disclosure, a task management service server capable performing task management for an electronic terminal and the operating method thereof are provided to support an administrator to more easily perform task setting and management for an electronic terminal on a predetermined person to be managed.

### BRIEF DESCRIPTION OF THE DRAWINGS

FIG. 1 is a diagram illustrating a structure of a task management service server capable of performing task management for an electronic terminal according to an exemplary embodiment of the present disclosure.

FIG. 2 is a flowchart illustrating an operating method of a task management service server capable of performing task management for an electronic terminal according to an exemplary embodiment of the present disclosure.

### DETAILED DESCRIPTION

Hereinafter, exemplary embodiments of the present disclosure will be described in detail with reference to the accompanying drawings. The description does not limit the present disclosure to specific exemplary embodiments, and it should be understood that the present disclosure covers all the modifications, equivalents and replacements included within the idea and technical scope of the present disclosure. In describing each drawing, like reference numerals refer to like elements and if not contrarily defined, all terms used herein including technological or scientific terms have the same meanings as those generally understood by a person with ordinary skill in the art.

In the present disclosure, unless explicitly described to the contrary, the word “comprise” and variations such as “comprises” or “comprising”, will be understood to imply the inclusion of stated elements but not the exclusion of any other elements. Further, in various exemplary embodiments of the present disclosure, each of components, functional blocks or means may be constituted by one or more lower components and electrical, electronic, and mechanical functions performed by respective components may be implemented as various known devices or mechanical elements including an electronic circuit, an integrated circuit, an Application Specific Integrated Circuit (ASIC), etc., and the respective components may be separately implemented or two or more components may be integrated into one and implemented.

Meanwhile, blocks of the accompanying block diagram or steps of a flowchart may be appreciated as meaning compute program instructions mounted on a processor or a memory of data processible equipment such as a universal computer, a special computer, a portable notebook computer, a network computer, etc., and performing designated functions. Since the computer program instructions may be stored in a memory provided in a computer device or a computer readable memory, functions described in blocks of a block diagram or steps of a flowchart may be produced as a manufactured object including an instruction mean performing the functions. Moreover, each block or each step may represent a part of a module, a segment, or a code that includes one or more executable instructions for executing a specified logical function(s). It should also be noted that in some replaceable embodiments, the functions mentioned in the blocks or steps may also be executed differently from a predetermined order. For example, two blocks or steps that are subsequently illustrated are substantially simultaneously carried out, or may be performed in a reverse order, and in some cases, the functions may be performed while some blocks or steps are omitted.

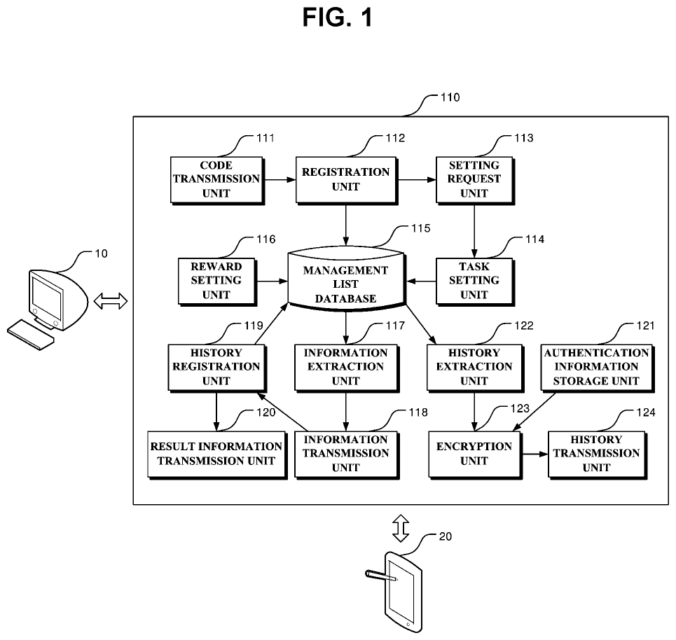

FIG. 1 is a diagram illustrating a structure of a task management service server capable of performing task management for an electronic terminal according to an exemplary embodiment of the present disclosure.

Referring to FIG. 1, the task management service server 110 according to the present disclosure includes a code transmission unit 111, a registration unit 112, a setting request unit 113, and a task setting unit 114.

When the code transmission unit 111 receives, from a management terminal 10 of an administrator, a processing request for a registration procedure for registering a terminal to be subjected to the task management, the code transmission unit 111 generates an identification code for identifying a connection session with the management terminal 10, and transmits the generated identification code to the management terminal 10.

In this case, according to an exemplary of the present disclosure, when the code transmission unit 111 receives the processing request for the registration procedure from the management terminal 10, the code transmission unit 111 may generate a t (t is a natural number of 2 or more)-digit random one-time number, and then transmit the one-time number to the management terminal 10 as the identification code.

In this case, according to an exemplary embodiment of the present disclosure, when the management terminal 10 receives the identification code from the task management service server 110, the management terminal 10 may display the identification code on a screen. Then, the administrator may apply the identification code as an input to the first electronic terminal 20, which becomes the subject of the task management, and in this case, when the first electronic terminal 20 receives the identification code input by the administrator, the first electronic terminal 20 may extract first unique identification information specified to the first electronic terminal 20, and transmit, to the task management service server 110, the first unique identification information together with the identification code.

Here, the first unique identification information which means unique information for identifying the first electronic terminal 20 may be a Media Access Control (MAC) address, an International Mobile Equipment Identity (IMEI), an IP address, Token, UUID, etc.

According to an exemplary embodiment of the present disclosure, when the management terminal 10 receives the identification code from the task management service server 110, the management terminal 10 may generate a 2D code inserted with the identification code, and display the 2D code on the screen. Here, the 2D code refers to a code capable of inserting various information on a 2D image pattern, and a quick response (QR) code, veri code, a dot code, and the like may be used.

As such, when the management terminal 10 displays the 2D code on the screen, the administrator may scan the 2D code displayed on the screen of the management terminal 10 through a camera mounted on the first electronic terminal 20. Then, the first electronic terminal 20 may acquire the identification code from the 2D code scanned through the camera, and when the identification code is acquired, the first electronic terminal 20 may extract the first unique identification information specified to the first electronic terminal 20, and transmit, to the task management service server 110, the first unique identification information together with the identification code.

As such, when the task management service server 110 receives the first unique identification information specified to the first electronic terminal 20 jointly with the identification code from the first electronic terminal 20 which becomes the subject of the task management, which acquires the identification code transmitted from the management terminal 10, the registration unit 112 identifies the connection session with the management terminal 10 based on the identification code, and stores the first unique identification information as the unique identification information for the terminal which becomes the subject of the task management specified by the administrator in the management list database 115.

When the first unique identification information is stored in the management list database 115, the setting request unit 113 transmits a setting request instruction for requesting setting a task list to be performed by a user of the first electronic terminal 20 to the management terminal 10.

Then, the administrator may set a predetermined task list through the management terminal 10 in response to the setting request instruction received by the management terminal 10. In this case, the administrator may set a first task list constituted by information on a plurality of tasks specified to be performed by the user of the first electronic terminal 20 and information on a time zone for which each of the plurality of task is to be performed, as the task list to be specified for the first electronic terminal 20.

For example, the administrator may set the first task list constituted by the information on the plurality of tasks shown in Table 1 below and the information on the time zone for which each of the plurality of tasks is to be performed through the management terminal 10.

TABLE 1

| | Time zone to be performed |
|---|---|
| Plurality of tasks | by each task |
| Brushing teeth 1 | 07 to 08 |
| Doing school homework | 17 to 18 |
| Brushing teeth 2 | 18 to 19 |
| Walk dog | 19 to 20 |
| . . . | . . . |

As such, when the administrator sets the first task list on the management terminal 10, the management terminal 10 may transmit the first task list to the task management service server 110.

As a result, when the task management service server 110 receives the first task list from the management terminal 10, the task setting unit 114 stores the first task list in a management list database 115 to correspond to the first unique identification information, generates an instruction message for instructing the user of the first electronic terminal 20 to perform the task according to the first task list, and then transmits the first task list and the instruction message to the first electronic terminal 20.

Then, the first electronic terminal 20 displays the first task list and the instruction message on the screen to induce the user of the first electronic terminal 20 to perform the task according to the first task list. Specifically, a control application for receiving the first task list from the task management service server 110 and displaying the first task list on the screen may be installed in the first electronic terminal 20. In this case, when the first electronic terminal 20 receives the first task list and the instruction message from the task management service server 110 of the present disclosure, the control application is driven to registering the first task list on the control application, and then display the first task list and the instruction message on the screen, which may induce the user of the first electronic terminal 20 to perform the plurality of tasks included in the first task list in the time zone for each task. In this case, whenever the user of the first electronic terminal 20 completes performing a predetermined task on the first task list, the user may manage whether to perform the task in the first task list by a scheme of applying a performing completion instruction for indicating that performing the task is completed through the control application.

According to an exemplary embodiment of the present disclosure, the task management service server 110 may further include a reward setting unit 116.

When the reward setting unit 116 receives a reward information registration request instruction together with reward information for each of the plurality of tasks included in the first task list from the management terminal 10, the reward setting unit 116 may store the reward information for each of the plurality of tasks in the management list database 115 to correspond to the first unique identification information, and then transmits the reward information for each of the plurality of tasks to the first electronic terminal 20.

Here, the reward information for each of the plurality of tasks means reward information specified to be provided to the user of the first electronic terminal 20 when the user of the first electronic terminal 20 completes the plurality of tasks.

In this regard, according to an exemplary embodiment of the present disclosure, as shown in Table 2 below, when it is assumed that there is an exchange token required to receive a reward for each predetermined reward detail, the reward information for each of the plurality of task, as shown in Table 3 below, as reward information specified by the administrator may be specified as a predetermined number of exchange tokens paid to be the user of the first electronic terminal 20 when the user of the first electronic terminal 20 completes the plurality of tasks.

TABLE 2

| | The number of exchange tokens |
|---|---|
| Reward detail | required for receiving reward |
| Pay $1 pocket money | 1 |
| Pay $2 pocket money | 2 |
| Using smartphone until 12 pm | 3 |
| Stay out at friend's house | 4 |
| . . . | . . . |

TABLE 3

| Plurality of tasks | Reward information |
|---|---|
| Brushing teeth 1 | Pay one exchange token |
| Doing school homework | Pay two exchange tokens |
| Brushing teeth 2 | Pay one exchange token |
| Walk dog | Pay three exchange tokens |
| . . . | . . . |

As such, after the first task list and the reward information are transmitted from the task management service server 110 to the first electronic terminal 20, among the plurality of tasks, when the user of the first electronic terminal 20 completes performing the first task in a first time zone specified as the first task is to be performed among the plurality of tasks, the user of the first electronic terminal 20 may apply a performing completion instruction for the first task on the first electronic terminal 20. Then, the first electronic terminal 20 may generate a performing completion instruction indicating that performing the first task is completed, and transmit the performing completion instruction to the task management service server 110 jointly with the first unique identification information.

In this case, according to an exemplary embodiment of the present disclosure, the task management service server 110 may further include an information extraction unit 117, an information transmission unit 118, a history registration unit 119, and a result information transmission unit 120.

The information extraction unit 117 confirms the first task list and the reward information for each of the plurality of tasks stored to correspond to the first unique identification information in the management list database 115, extracts information on the first task and information on the first time zone from the first task list, and extracts first reward information for the first task among the reward information for each the plurality of tasks, when the user of the first electronic terminal 20 completes performing the first task in the first time zone specified as the first task is to be performed among the plurality of tasks and as the performing completion instruction for the first task is applied onto the first electronic terminal 20, a performing completion instruction indicating that performing the first task is completed is received from the first electronic terminal 20 jointly with the first unique identification information.

For example, when it is assumed that a performing completion instruction for the task ‘doing school homework’ is received from the first electronic terminal 20 jointly with the first unique identification information, the information extraction unit 117 confirms the first task list shown in Table 1 above and the reward information for each of the plurality of tasks shown in Table 3 above, which are stored in the management list database 115 to correspond to the first unique identification information, extracts task information ‘dong school homework’ and time zone information ‘17 to 18’ from the first task list, and extract the reward information ‘paying two exchange tokens’ as the reward information for the task ‘doing school homework’ among the reward information for each of the plurality of tasks.

The information transmission unit 118 transmits the information on the first task and the information on the first time zone to the management terminal 10 as description information on the task completed by the user of the first electronic terminal 20, and at the same time, transmits a query message for querying whether the performing completion of the first task is finally approved to the management terminal 10 while transmitting the first reward information to the management terminal 10.

That is, according to the above example, the information transmission unit 118 may transmit the task information ‘doing school homework’ and the time zone information ‘17 to 18’ to the management terminal 10 as the description information for the task completed by the user of the first electronic terminal 20, and at the same, transmit the query message for querying whether the performing completion of the task ‘doing school homework’ is finally approved to the management terminal 10 while transmitting the reward information ‘paying two exchange tokens’ to the management terminal 10. Then, the administrator may confirm the information received by the management terminal 10, determine whether to finally approve the performing completion of the task of ‘doing school homework’, and then input an instruction according to the determination result into the management terminal 10.

When the history registration unit 119 receives, in response to the query message, an approval message indicating that the performing completion of the first task is finally approved from the management terminal 10, the history registration unit 119 generates first task performing history information constituted by date/time information of a current time point, information on the first task, information on the first time zone, and the first reward information, and then stores the first task performing history information in the management list database 115 to correspond to the first unique identification information.

In this regard, as compared with the above example, when the operation of the history registration unit 119 is described, the history registration unit 119, in response to the query message, receives an approval message indicating that the performing completion of the task “doing school homework’ is finally approved from the management terminal 10, the history registration unit 119 may generate the first task performing history information shown in Table 4 below, and then store the first task performing history information in the management list database 115 to correspond to the first unique identification information.

TABLE 4

| Date/time information | Information | Information | Reward |
|---|---|---|---|
| of current time point | on task | on time zone | information |
| 18:30 on | Doing school | 17 to 18 | Paying two |
| Oct. 19, 2022 | homework | | exchange |
| | | | tokens |

As such, when storing the first task performing history information is completed, the result information transmission unit 120 transmits the approval message to the first electronic terminal 20 and simultaneously transmits the first task performing history information.

According to the scheme described so far, when the performing completion for the first task is finally approved, and the first task performing history information has been stored in the management list database 115 by the administrator, the administrator may provide a predetermined reward according to the first reward information for the first task to the user of the first electronic terminal 20. That is, as in the above example, when the performing completion of the task ‘doing school homework’ is finally approved, the administrator may provide the user of the first electronic terminal 20 with a reward of ‘paying of two exchange tokens’. In this case, according to another exemplary embodiment of the present disclosure, the task management service server 110 issues two exchange tokens to the first electronic terminal 20 to automatically perform reward provision processing called ‘paying two exchange tokens’ without separate intervention of the administrator when the performing completion of the task ‘doing school homework’ is finally approved. As such, as a reward for completing the task of ‘doing school homework’ to the user of the first electronic terminal 20, when two exchange tokens have been paid, the user of the first electronic terminal 20 may request a reward detail according to the table shown in Table 2 to the administrator by using exchange tokens later collected thereby, and in this case, the administrator may make a predetermined reward according to the request of the user of the first electronic terminal 20.

According to an exemplary embodiment of the present disclosure, the task management service server 110 may further include an authentication information storage unit 121, a history extraction unit 122, an encryption unit 123, and a history transmission unit 124.

The authentication information storage unit 121 stores a preset authentication number with n (n is a natural number of 2 or more) digits and a predetermined hash function which is shared in advance with the management terminal 10.

The history extraction unit 122 receives, from the management terminal 10, a provision request instruction of the first task performing history information stored in correspondence to the first unique identification information in the management list database 115, the history extraction unit 122 extracts, from the management list database 115, the first task performance history information stored in correspondence to the first unique identification information.

The encryption unit 123 randomly generates an n-digit serial number, and then generates a column vector having each digit of numbers constituting the serial number as a component and a row vector having each digit constituting the authentication number as a component, and computes a matrix multiplication between the column vector and the row vector to generate an n×n size computation matrix, and then randomly selects a first component which is one of the components constituting the computation matrix, and applies the first component to the hash function as an input to generate a first hash value, and encrypts the first task performing history information based on the first hash value.

For example, when it is assumed that n is ‘3’, the authentication number stored in the authentication information storage unit 121 is ‘231’, and the serial number is randomly generated as in ‘425’, the encryption unit 123 generates

$$‘ [ \begin{matrix}4 \\ 2 \\ 5\end{matrix} ] ’$$

which is a column vector having the serial number ‘425’ as the component, generates ‘[2 3 1]’ which is a row vector having the authentication number ‘231’ as the component, and then computes the matrix multiplication between the column vector and the row vector to generate a 3×3 size computation matrix as in

$$‘ [ \begin{matrix}8 & 12 & 4 \\ 4 & 6 & 2 \\ 10 & 15 & 5\end{matrix} ] ’ .$$

Then, the encryption unit 123 randomly selects the first component which is any one of the components constituting the computation matrix as ‘15’, and applies the first component ‘15’ to the hash function stored in the authentication information storage unit 121 as the input to generate the first hash value, and then encrypt the first task performing history information based on the first hash value.

The history transmission unit 124 substitutes the first component with a randomly generated dummy component (the dummy component is generated as a different value from the first component) to generate a substitution matrix in the computation matrix, and encrypts each of the substitution matrix and the serial number with a predetermined public key (a private key forming a key pair with the public key is stored in the management terminal 10), and then transmits the encrypted substitution matrix and the encrypted serial number to the management terminal 10, and at the same time, transmits the encrypted first task performing history information to the management terminal 10.

In this regard, as in the above example, when the computation matrix is generated as in

$$‘ [ \begin{matrix}8 & 12 & 4 \\ 4 & 6 & 2 \\ 10 & 15 & 5\end{matrix} ] ’ ,$$

and the first component is ‘15’, the history transmission unit 124 may substitute the component ‘15’ with the random dummy component ‘27’ in the computation matrix to generate the substitution matrix

$$‘ [ \begin{matrix}8 & 12 & 4 \\ 4 & 6 & 2 \\ 10 & 27 & 5\end{matrix} ] ’ ,$$

and encrypt each of the substitution matrix and the serial number with the public key, and then transmit the encrypted substitution matrix and the encrypted serial number to the management terminal 10, and at the same time, transmit the encrypted first task performing history information to the management terminal 10.

In this case, according to an exemplary embodiment of the present disclosure, the management terminal 10 store, in advance, the private key, the authentication number, and the hash function in the memory, decrypts, when receiving, from the task management service server 110, the encrypted substitution matrix, the encrypted serial number, and the encrypted first task performing history information, each of the substitution matrix encrypted and the serial number encrypted based on the private key, and then generate a column vector having respective digits of numbers constituting the decrypted serial number as the component and a row vector having respective digits of numbers constituting the authentication number stored in the memory as the component, and computes the matrix multiplication between the column vector and the row vectors to the computation matrix to generate the computation matrix having an n×n size, and then compare the computation matrix and the decrypted substitution matrix, and extract a component in the computation matrix, which does not match the substitution matrix as the first component, and apply the first component to the hash function stored in the memory as the input to calculate the first hash value, and then decrypt the encrypted first task performing history information based on the first hash value.

In this regard, as in the above example, if the authentication number and the serial number are ‘231’ and ‘425’, respectively, and the computation matrix and the substitution matrix are

$$‘ [ \begin{matrix}8 & 12 & 4 \\ 4 & 6 & 2 \\ 10 & 15 & 5\end{matrix} ] ’$$

and

$$‘ [ \begin{matrix}8 & 12 & 4 \\ 4 & 6 & 2 \\ 10 & 27 & 5\end{matrix} ] ’ ,$$

respectively, when the management terminal 10 receives the encrypted substitution matrix, the encrypted serial number, and the encrypted first task performing history information from the task management service server 110, the management terminal 20 may decrypt each of the encrypted substitution matrix and the encrypted serial number based on the private key, and then generate the column vector having each digit number constituting the decrypted serial number ‘425 as the component as

$$‘ [ \begin{matrix}4 \\ 2 \\ 5\end{matrix} ] ’ ,$$

and generate the row vector having each digit number constituting ‘231’ which is the authentication number stored in the memory as the component as ‘[2 3 1]’.

Then, the management terminal 10 computes the matrix multiplication between the column vector and the row vector to generate the computation matrix having the 3×3 size as in

$$‘ [ \begin{matrix}8 & 12 & 4 \\ 4 & 6 & 2 \\ 10 & 15 & 5\end{matrix} ] ’ .$$

Thereafter, the management terminal 10 compares the computation matrix

$$‘ [ \begin{matrix}8 & 12 & 4 \\ 4 & 6 & 2 \\ 10 & 15 & 5\end{matrix} ] ’$$

and the decrypted substitution matrix

$$‘ [ \begin{matrix}8 & 12 & 4 \\ 4 & 6 & 2 \\ 10 & 27 & 5\end{matrix} ] ’$$

with each other to extract ‘15’ which is the component in the computation matrix, which does not match the substitution matrix as the first component, and when the first component ‘15’ is extracted, the management terminal 10 applies the first component ‘15’ to the hash function stored in the memory as the input to calculate the first hash value, and then decrypt the encrypted first task performing history information based on the first hash value.

Through this, when the administrator provides the reward to the user of the first electronic terminal 20, the administrator confirms the first task performing history information through the management terminal 10 to confirm whether the user of the first electronic terminal 20 completes performing the first task once again.

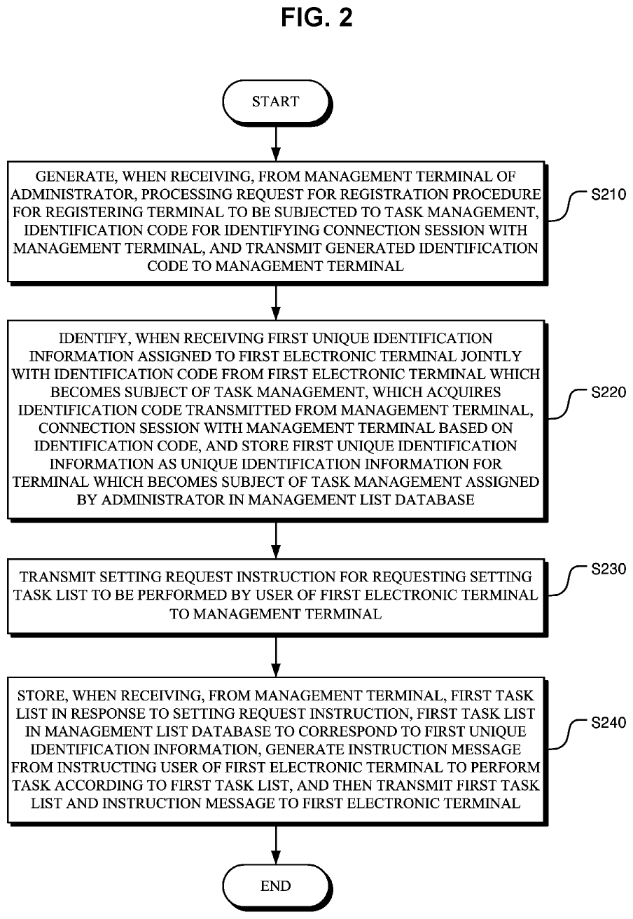

FIG. 2 is a flowchart illustrating an operating method of a task management service server capable of performing task management for an electronic terminal according to an exemplary embodiment of the present disclosure.

In step S210, when receiving, from the management terminal of the administrator, a processing request for a registration procedure for registering a terminal to be subjected to the task management, an identification code for identifying a connection session with the management terminal is generated, and the generated identification code is transmitted to the management terminal.

In step S220, when receiving the first unique identification information assigned to the first electronic terminal jointly with the identification code from the first electronic terminal which becomes the subject of the task management, which acquires the identification code transmitted from the management terminal, the connection session with the management terminal is identified based on the identification code, and the first unique identification information as the unique identification information for the terminal which becomes the subject of the task management assigned by the administrator is stored in the management list database.

In step S230, a setting request instruction for requesting setting a task list to be performed by a user of the first electronic terminal is transmitted to the management terminal.

In step S240, when receiving, from the management terminal, a first task list, in which the first task list is a list constituted by information on each of a plurality of tasks specified for the user of the first electronic terminal to perform and information on a time zone in which each of the plurality of tasks is to be performed in response to the setting request instruction, the first task list is stored in a management list database to correspond to the first unique identification information, an instruction message for instructing the user of the first electronic terminal to perform the task according to the first task list is generated, and then the first task list and the instruction message are transmitted to the first electronic terminal.

In this case, according to an exemplary embodiment of the present disclosure, when the management terminal receives the identification code from the task management service server, the management terminal may generate a 2D code inserted with the identification code, and display the 2D code on the screen, and in this case, the first electronic terminal may acquire the identification code by scanning the 2D code displayed on the screen of the management terminal through a camera mounted on the first electronic terminal, and then extract, when the identification code is acquired, the first unique identification information specified to the first electronic terminal, and transmit the first unique identification information to the task management service server jointly with the identification code.

According to an exemplary embodiment of the present disclosure, the operating method of the task management service server may further include: storing, when receiving a reward information registration request instruction together with reward information, in which the reward information for each of the plurality of tasks means reward information specified to be provided to the user of the first electronic terminal when the user of the first electronic terminal completes the plurality of tasks, for each of the plurality of tasks included in the first task list from the management terminal, the reward information for each of the plurality of tasks in the management list database to correspond to the first unique identification information, and then transmitting the reward information for each of the plurality of tasks to the first electronic terminal.

According to an exemplary embodiment of the present disclosure, the operating method of the task management service server may further include: confirming the first task list and the reward information for each of the plurality of tasks stored to correspond to the first unique identification information in the management list database, extracting information on the first task and information on the first time zone from the first task list, and extracting first reward information for the first task among the reward information for each the plurality of tasks, when the user of the first electronic terminal completes performing the first task in the first time zone specified as a first task is to be performed among the plurality of tasks and as the performing completion instruction for the first task is applied onto the first electronic terminal, a performing completion instruction indicating that performing the first task is completed is received jointly with the first unique identification information from the first electronic terminal; transmitting the information on the first task and the information on the first time zone to the management terminal as description information on the task completed by the user of the first electronic terminal, and at the same time, transmitting a query message for querying whether the performing completion of the first task is finally approved to the management terminal while transmitting the first reward information to the management terminal; generating, when receiving, in response to the query message, an approval message indicating that the performing completion of the first task is finally approved from the management terminal, the history registration unit 119 stores first task performing history information constituted by date/time information of a current time point, information on the first task, information on the first time zone, and the first reward information, and then generating the first task performing history information in the management list database to correspond to the first unique identification information; and transmitting the approval message to the first electronic terminal and simultaneously transmitting the first task performing history information.

In this case, according to an exemplary embodiment of the present disclosure, an operating method of the task management service server may further include: maintaining an authentication information storage unit storing a preset authentication number with n (n is a natural number of 2 or more) digits and a predetermined hash functions which is shared in advance with the management terminal; extracting, when receiving, from the management terminal, a provision request instruction of the first task performing history information stored in correspondence to the first unique identification information in the management list database, from the management list database, the first task performance history information stored in correspondence to the first unique identification information; randomly generating an n-digit serial number, and then generates a column vector having each digit of numbers constituting the serial number as a component and a row vector having each digit of numbers constituting the authentication number as a component, and computing a matrix multiplication between the column vector and the row vector to generate an n×n size computation matrix, and then randomly selecting a first component which is one of the components constituting the computation matrix, and applying the first component to the hash function as an input to generate a first hash value, and encrypting the first task performing history information based on the first hash value; and substituting the first component with a randomly generated dummy component (the dummy component is generated as a different value from the first component) to generate a substitution matrix in the computation matrix, and encrypting each of the substitution matrix and the serial number with a predetermined public key (a private key forming a key pair with the public key is stored in the management terminal), and then transmitting the encrypted substitution matrix and the encrypted serial number to the management terminal, and at the same time, transmitting the encrypted first task performing history information to the management terminal.

In this case, the management terminal may store, in advance, the private key, the authentication number, and the hash function in the memory, decrypts, when receiving, from the task management service server, the encrypted substitution matrix, the encrypted serial number, and the encrypted first task performing history information, each of the substitution matrix encrypted and the serial number encrypted based on the private key, and then generate a column vector having respective digits of numbers constituting the decrypted serial number as the component and a row vector having respective digits of numbers constituting the authentication number stored in the memory as the component, and computes the matrix multiplication between the column vector and the row vectors to generate the computation matrix having an n×n size, and then compare the computation matrix and the decrypted substitution matrix, and extract a component in the computation matrix, which does not match the substitution matrix as the first component, and apply the first component to the hash function stored in the memory as the input to calculate the first hash value, and then decrypt the encrypted first task performing history information based on the first hash value.

Hereinabove, referring to FIG. 2, the operating method of the task management service server according to an exemplary embodiment of the present disclosure is described. Here, since the operating method of task management service server according to an exemplary embodiment of the present disclosure may correspond to the configuration of the operation of the task management service server 110 described by using FIG. 1, a more detailed description thereof will be omitted.

The operating method of the task management service server according to an exemplary embodiment of the present disclosure may be implemented by a computer program stored in a storage medium for executing the computer program through coupling with a computer.

The operation method of the task management service server according to an exemplary embodiment of the present disclosure may be implemented in a program command type which may be performed through various computer means and recorded in a computer readable medium. The computer readable medium may include a program command, a data file, a data structure, etc., singly or combinationally. The program command recorded in the medium may be specially designed and configured for the present disclosure, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

As described above, the present disclosure has been described by specified matters such as detailed components, and the like and limited exemplary embodiments and drawings, but the description is just provided to assist more overall understanding of the present disclosure and the present disclosure is not limited to the exemplary embodiment and various modifications and changes can be made by those skilled in the art from such a disclosure.

Accordingly, the spirit of the present disclosure should not be defined only by the described exemplary embodiments, and it should be appreciated that claims to be described below and all things which are equivalent to the claims or equivalently modified to the claims are included in the scope of the spirit of the present disclosure.

What is claimed is:

1. A task management service server capable of performing task management for an electronic terminal, comprising:
a code transmission unit generating, when receiving, from a management terminal of an administrator, a processing request for a registration procedure for registering a terminal to be subjected to the task management, an identification code for identifying a connection session with the management terminal, and transmitting the generated identification code to the management terminal;
a registration unit identifying, when receiving first unique identification information assigned to the first electronic terminal jointly with the identification code from the first electronic terminal which becomes the subject of the task management, which acquires the identification code transmitted from the management terminal, the connection session with the management terminal based on the identification code, and storing the first unique identification information as the unique identification information for the terminal which becomes the subject of the task management assigned by the administrator in the management list database;
a setting request unit transmitting a setting request instruction for requesting setting a task list to be performed by a user of the first electronic terminal to the management terminal; and
a task setting unit storing, when receiving, from the management terminal, a first task list, wherein the first task list is a list constituted by information on each of a plurality of tasks specified for the user of the first electronic terminal to perform and information on a time zone in which each of the plurality of tasks is to be performed, in response to the setting request instruction, the first task list in a management list database to correspond to the first unique identification information, generating an instruction message from instructing the user of the first electronic terminal to perform the task according to the first task list, and then transmitting the first task list and the instruction message to the first electronic terminal.

2. The task management service server of claim 1, wherein when the management terminal receives the identification code from the task management service server, the management terminal may generate a 2D code inserted with the identification code, and display the 2D code on the screen, and in this case, the first electronic terminal acquires the identification code by scanning the 2D code displayed on the screen of the management terminal through a camera mounted on the first electronic terminal, and then extracts, when the identification code is acquired, the first unique identification information specified to the first electronic terminal, and transmits the first unique identification information to the task management service server jointly with the identification code.

3. The task management service server of claim 1, further comprising:
a reward setting unit storing, when receiving a reward information registration request instruction together with reward information, wherein the reward information for each of the plurality of tasks means reward information specified to be provided to the user of the first electronic terminal when the user of the first electronic terminal completes the plurality of tasks, for each of the plurality of tasks included in the first task list from the management terminal, the reward information for each of the plurality of tasks in the management list database to correspond to the first unique identification information, and then transmitting the reward information for each of the plurality of tasks to the first electronic terminal.

4. The task management service server of claim 3, further comprising:
an information extraction unit confirming the first task list and the reward information for each of the plurality of tasks stored to correspond to the first unique identification information in the management list database, extracting information on a first task and information on a first time zone from the first task list, and extracting first reward information for the first task among the reward information for each the plurality of tasks, when the user of the first electronic terminal completes performing the first task in the first time zone specified as the first task is to be performed among the plurality of tasks and as a performing completion instruction for the first task is applied onto the first electronic terminal, the performing completion instruction indicating that performing the first task is completed is received jointly with the first unique identification information from the first electronic terminal;
an information transmission unit transmitting the information on the first task and the information on the first time zone to the management terminal as description information on the task completed by the user of the first electronic terminal, and at the same time, transmitting a query message for querying whether the performing completion of the first task is finally approved to the management terminal while transmitting the first reward information to the management terminal;
a history registration unit generating, when receiving, in response to the query message, an approval message indicating that the performing completion of the first task is finally approved from the management terminal, first task performing history information constituted by date/time information of a current time point, information on the first task, information on the first time zone, and the first reward information, and then storing the first task performing history information in the management list database to correspond to the first unique identification information; and
a result information transmission unit transmitting the approval message to the first electronic terminal and simultaneously transmitting the first task performing history information.

5. The task management service server of claim 4, further comprising:
an authentication information storage unit storing a preset authentication number with n, wherein n is a natural number of 2 or more, digits and a predetermined hash function which is shared in advance with the management terminal;
a history extraction unit extracting, when receiving, from the management terminal, a provision request instruction of the first task performing history information stored in correspondence to the first unique identification information in the management list database, from the management list database, the first task performance history information stored in correspondence to the first unique identification information;
an encryption unit randomly generating an n-digit serial number, and then generates a column vector having each digit of numbers constituting the serial number as a component and a row vector having each digit of numbers constituting the authentication number as a component, and computing a matrix multiplication between the column vector and the row vector to generate an n×n size computation matrix, and then randomly selecting a first component which is one of the components constituting the computation matrix, and applying the first component to the hash function as an input to generate a first hash value, and encrypting the first task performing history information based on the first hash value; and
a history transmission unit substituting the first component with a randomly generated dummy component, wherein the dummy component is generated as a different value from the first component, to generate a substitution matrix in the computation matrix, and encrypting each of the substitution matrix and the serial number with a predetermined public key, wherein a private key forming a key pair with the public key is stored in the management terminal, and then transmitting the encrypted substitution matrix and the encrypted serial number to the management terminal, and at the same time, transmitting the encrypted first task performing history information to the management terminal,
wherein the management terminal stores, in advance, the private key, the authentication number, and the hash function in the memory, decrypts, when receiving, from the task management service server, the encrypted substitution matrix, the encrypted serial number, and the encrypted first task performing history information, each of the substitution matrix and the serial number based on the private key, and then generates a column vector having respective digits of numbers constituting the decrypted serial number as the component and a row vector having respective digits of numbers constituting the authentication number stored in the memory as the component, and computes the matrix multiplication between the column vector and the row vectors to generate the computation matrix having an n×n size, and then compares the computation matrix and the decrypted substitution matrix, and extracts a component in the computation matrix, which does not match the substitution matrix as the first component, and applies the first component to the hash function stored in the memory as the input to calculate the first hash value, and then decrypts the encrypted first task performing history information based on the first hash value.

6. An operating method of a task management service server capable of performing task management for an electronic terminal, comprising:
generating, when receiving, from a management terminal of an administrator, a processing request for a registration procedure for registering a terminal to be subjected to the task management, an identification code for identifying a connection session with the management terminal, and transmitting the generated identification code to the management terminal;
identifying, when receiving first unique identification information assigned to the first electronic terminal jointly with the identification code from the first electronic terminal which becomes the subject of the task management, which acquires the identification code transmitted from the management terminal, the connection session with the management terminal based on the identification code, and storing the first unique identification information as the unique identification information for the terminal which becomes the subject of the task management assigned by the administrator in the management list database;
transmitting a setting request instruction for requesting setting a task list to be performed by a user of the first electronic terminal to the management terminal; and
storing, when receiving, from the management terminal, a first task list, wherein the first task list is a list constituted by information on each of a plurality of tasks specified for the user of the first electronic terminal to perform and information on a time zone in which each of the plurality of tasks is to be performed in response to the setting request instruction, the first task list in a management list database to correspond to the first unique identification information, generating an instruction message from instructing the user of the first electronic terminal to perform the task according to the first task list, and then transmitting the first task list and the instruction message to the first electronic terminal.

7. The operating method of a task management service server of claim 6, wherein when the management terminal receives the identification code from the task management service server, the management terminal may generate a 2D code inserted with the identification code, and display the 2D code on the screen, and in this case, the first electronic terminal acquires the identification code by scanning the 2D code displayed on the screen of the management terminal through a camera mounted on the first electronic terminal, and then extracts, when the identification code is acquired, the first unique identification information specified to the first electronic terminal, and transmits the first unique identification information to the task management service server jointly with the identification code.

8. The operating method of a task management service server of claim 6, further comprising:
storing, when receiving a reward information registration request instruction together with reward information, wherein the reward information for each of the plurality of tasks means reward information specified to be provided to the user of the first electronic terminal when the user of the first electronic terminal completes the plurality of tasks, for each of the plurality of tasks included in the first task list from the management terminal, the reward information for each of the plurality of tasks in the management list database to correspond to the first unique identification information, and then transmitting the reward information for each of the plurality of tasks to the first electronic terminal.

9. The operating method of a task management service server of claim 8, further comprising:
confirming the first task list and the reward information for each of the plurality of tasks stored to correspond to the first unique identification information in the management list database, extracting information on a first task and information on a first time zone from the first task list, and extracting first reward information for the first task among the reward information for each the plurality of tasks, when the user of the first electronic terminal completes performing the first task in the first time zone specified as the first task is to be performed among the plurality of tasks and as a performing completion instruction for the first task is applied onto the first electronic terminal, the performing completion instruction indicating that performing the first task is completed is received jointly with the first unique identification information from the first electronic terminal;
transmitting the information on the first task and the information on the first time zone to the management terminal as description information on the task completed by the user of the first electronic terminal, and at the same time, transmitting a query message for querying whether the performing completion of the first task is finally approved to the management terminal while transmitting the first reward information to the management terminal;
generating, when receiving, in response to the query message, an approval message indicating that the performing completion of the first task is finally approved from the management terminal, first task performing history information constituted by date/time information of a current time point, information on the first task, information on the first time zone, and the first reward information, and then storing the first task performing history information in the management list database to correspond to the first unique identification information; and
transmitting the approval message to the first electronic terminal and simultaneously transmitting the first task performing history information.

10. The operating method of a task management service server of claim 9, further comprising:
maintaining an authentication information storage unit storing a preset authentication number with n, wherein n is a natural number of 2 or more, digits and a predetermined hash function which is shared in advance with the management terminal;
extracting, when receiving, from the management terminal, a provision request instruction of the first task performing history information stored in correspondence to the first unique identification information in the management list database, from the management list database, the first task performance history information stored in correspondence to the first unique identification information;
randomly generating an n-digit serial number, and then generates a column vector having each digit of numbers constituting the serial number as a component and a row vector having each digit of numbers constituting the authentication number as a component, and computing a matrix multiplication between the column vector and the row vector to generate an n×n size computation matrix, and then randomly selecting a first component which is one of the components constituting the computation matrix, and applying the first component to the hash function as an input to generate a first hash value, and encrypting the first task performing history information based on the first hash value; and
substituting the first component with a randomly generated dummy component, wherein the dummy component is generated as a different value from the first component, to generate a substitution matrix in the computation matrix, and encrypting each of the substitution matrix and the serial number with a predetermined public key, wherein a private key forming a key pair with the public key is stored in the management terminal, and then transmitting the encrypted substitution matrix and the encrypted serial number to the management terminal, and at the same time, transmitting the encrypted first task performing history information to the management terminal,
wherein the management terminal stores, in advance, the private key, the authentication number, and the hash function in the memory, decrypts, when receiving, from the task management service server, the encrypted substitution matrix, the encrypted serial number, and the encrypted first task performing history information, each of the substitution matrix and the serial number based on the private key, and then generates a column vector having respective digits of numbers constituting the decrypted serial number as the component and a row vector having respective digits of numbers constituting the authentication number stored in the memory as the component, and computes the matrix multiplication between the column vector and the row vectors to generate the computation matrix having an n×n size, and then compares the computation matrix and the decrypted substitution matrix, and extracts a component in the computation matrix, which does not match the substitution matrix as the first component, and applies the first component to the hash function stored in the memory as the input to calculate the first hash value, and then decrypts the encrypted first task performing history information based on the first hash value.

11. A non-transitory computer readable recording medium having a program recorded therein for allowing a computer to execute an operating method of a task management service server capable of performing task management for an electronic terminal, comprising:
generating, when receiving, from a management terminal of an administrator, a processing request for a registration procedure for registering a terminal to be subjected to the task management, an identification code for identifying a connection session with the management terminal, and transmitting the generated identification code to the management terminal;
identifying, when receiving first unique identification information assigned to the first electronic terminal jointly with the identification code from the first electronic terminal which becomes the subject of the task management, which acquires the identification code transmitted from the management terminal, the connection session with the management terminal based on the identification code, and storing the first unique identification information as the unique identification information for the terminal which becomes the subject of the task management assigned by the administrator in the management list database;
transmitting a setting request instruction for requesting setting a task list to be performed by a user of the first electronic terminal to the management terminal; and
storing, when receiving, from the management terminal, a first task list, wherein the first task list is a list constituted by information on each of a plurality of tasks specified for the user of the first electronic terminal to perform and information on a time zone in which each of the plurality of tasks is to be performed in response to the setting request instruction, the first task list in a management list database to correspond to the first unique identification information, generating an instruction message from instructing the user of the first electronic terminal to perform the task according to the first task list, and then transmitting the first task list and the instruction message to the first electronic terminal.
